(19) United States
(12) Patent Application Publication
(10) Pub. No.: US 2008/0013607 A1
(43) Pub. Date: Jan. 17, 2008

(54) Apparatus and a method for processing signals from a device

(75) Inventors: Wong Hoo Sim, Singapore (SG); Long Chye Low, Singapore (SG); Gin Eng Kua, Singapore (SG); Juinn Shyong Neo, Singapore (SG)

Correspondence Address: CREATIVE LABS, INC.;LEGAL DEPARTMENT, 1901 MCCARTHY BLVD, MILPITAS, CA, 95035, US

(73) Assignee: Creative Technology Ltd

(21) Appl. No.: 11/444,733

(22) Filed: May 31, 2006

(51) Int. Cl. H04L 5/16

(52) U.S. Cl. 375/220

(57) ABSTRACT

There is provided an apparatus for processing incoming signals, the apparatus comprising: a first connector of a first interface for operative connection with a corresponding second connector of an interface of a first device; a third connector of a second interface for operative connection with a corresponding fourth connector of an interface of a second device, and a processor to process the incoming signals received from the first device through the first interface and transmitting the processed signals through the second interface to the second device. Advantageously, the processor adjusts the processed signals affecting audio output in a manner like volume, treble, bass, balance or fader. It is preferable that the second device may be selected from the group consisting of: another apparatus for processing digital signals, a set of speakers, a computer, a device with speakers, a television, and a mobile phone. Similarly, the first device may be selected from the group consisting of: another apparatus for processing digital signals, a media player, a mobile phone, a computer, a VCR and a PDA. A corresponding method for processing signals from a device is also disclosed.

### FIELD OF INVENTION

This invention relates to an apparatus and a method for processing input from a device, and particularly relates to an apparatus and a method used as an intermediary input signal processing accessory.

### BACKGROUND

The era of digital entertainment has been ushered in by explosive growth in the number of digital media devices being sold, especially portable versions meant for individual use. Coupled to this explosive growth in the sales of portable media devices has been the exponential growth in the sales of add-on peripherals for the portable media devices.

A popular add-on peripheral for such portable media devices is a set of speakers as they enable the audio content of the portable media devices to be enjoyed by more than one person at a time. However, the speakers currently available merely amplify audio signals transmitted from the portable media devices connected to them and do not process the audio signals in any other significant manner. In this regard, nothing is done to the audio signals to compensate for the loss in quality of the audio content in the portable media devices as a result of compression of the media content stored as file formats such as, for example, MP3, WMA, AAC, AVI, MP4, and the like. As a result, the quality of playback of audio content from the portable media devices using such peripherals has room for improvement.

The increasing popularity of high definition televisions means that existing video cassette/LDNCD/DVD collections of consumers will not be able to enjoy images in high definition format because of the limitations of their collections. As such, consumers need to make expensive decisions whether to replace their collections or to continue to watch their collections at a lower quality on their high definition televisions. There is currently no device that allows for existing video collections to be converted to high definition format during playback of content.

### SUMMARY

There is provided an apparatus for processing incoming signals, the apparatus comprising: a first connector of a first interface of the apparatus for operative connection with a corresponding second connector of an interface of a first device; a third connector of a second interface of the apparatus for operative connection with a corresponding fourth connector of an interface of a second device, and a processor to process the incoming signals passing into the apparatus from the first device through the first interface of the apparatus and subsequently passing processed signals through the second interface of the apparatus to the second device. Advantageously, the processor adjusts the processed signals affecting audio output in a manner like volume, treble, bass, balance or fader. It is preferable that the second device may be selected from the group comprising: another apparatus for processing digital signals, a set of speakers, a computer, a device with speakers, a television, and a mobile phone. Similarly, the first device may be selected from the group comprising: another apparatus for processing digital signals, a media player, a mobile phone, a computer, a VCR and a PDA.

Advantageously, the incoming signals are processed in a manner such as, for example, by restoring compressed signals to approximately its original form, by using Creative Technology Ltd's X-Fi technology or by augmenting signals to high definition format. It is also advantageous that the processor is controllable. The incoming signals may be either digital or analog.

It is advantageous that when the first interface and second interface of the apparatus are able to be used, a power connection of the third connector and the fourth connector is able to be used to provide electrical power to the first device from the second device. The apparatus may further include a fifth connector of a first interface of the apparatus for operative connection with a corresponding second connector of an interface of a subsequent first device. The first connector and the fifth connector of the first interface of the apparatus may be either identical or different. All the connectors may be coupling parts selected from the group comprising: a USB connector, an IEEE 1394 Firewire connector, an earphone jack connector, a SCART connector, an S-Video connector and a proprietary connector set.

The apparatus may further comprise a transceiver for wireless functionality using technologies such as, for example, UWB, Bluetooth, infrared, and any form of radio frequency transmission. The apparatus may preferably further include a remote control for operative control of the processor and/or the transceiver for wireless functionality. It is advantageous that the apparatus may further include a decoder for decoding the incoming signals passing into the apparatus into multiple channels. The interface of the second device may reside in a receptor in the second device.

It is preferable that the apparatus may further include a receiving structure to support the first device in a stationary position. The receiving structure may be interchangeable.

There is also provided a method for processing incoming signals comprising: connecting a first device to an apparatus for processing incoming signals; and connecting the apparatus for processing incoming signals to a second device. The incoming signals may be either digital or analog. It is preferable that the apparatus for processing incoming signals processes incoming signals passing into the apparatus for processing incoming signals from the first device connected to the apparatus for processing incoming signals and subsequently passes processed signals to the second device. The first device may be another apparatus for processing digital signals, a media player, a mobile phone, a computer, a VCR or a PDA. Similarly, the second device may be another apparatus for processing digital signals, a set of speakers, a computer, a device with speakers, a television, or a mobile phone.

It is advantageous that the incoming signals are processed by a processor in the apparatus for processing incoming signals. The incoming signals may be processed by restoring compressed signals to approximately its original form, by using Creative Technology Ltd's X-Fi technology or by augmenting signals to high definition format. The processor may preferably adjust the processed signals affecting audio output in a manner such as, for example, volume, treble, bass, balance or fader. It is preferable that the processor is controllable.

### DESCRIPTION OF DRAWINGS

In order that the present invention may be fully understood and readily put into practical effect, there shall now be described by way of non-limitative example only preferred embodiments of the present invention, the description being with reference to the accompanying illustrative drawings.

FIG. 1a shows a first embodiment of the present invention when in use in a first instance.

FIG. 1b shows a view of a base of the first device 22 shown in FIG. 1a.

FIG. 1c shows a top view of the receptor 38 shown in FIG. 1a.

FIG. 1d shows a view of a base of a first embodiment of the present invention.

FIG. 2 shows a block diagram of the present invention.

FIG. 3 shows the first embodiment of the present invention when in use in a second instance.

FIG. 4 shows the first embodiment of the present invention when in use in a third instance.

FIG. 5a shows a second embodiment of the present invention in use from the front view.

FIG. 5b shows a base of the first device 22 in use with the second embodiment of the present invention.

FIG. 6 shows the second embodiment of the present invention in use from the top view.

FIG. 7 shows the second embodiment of the present invention in use from the side view.

FIG. 8 shows a third embodiment of the present invention in use from the front view.

FIG. 9 shows a process flow of a method of the present invention.

### DESCRIPTION OF PREFERRED EMBODIMENTS

The following discussion is intended to provide a brief, general description of the present invention. As those skilled in the art will appreciate, the term “computer” may encompass desktop terminals, notebooks, tablet PCs, Origami handhelds and other microprocessor-based electronic devices.

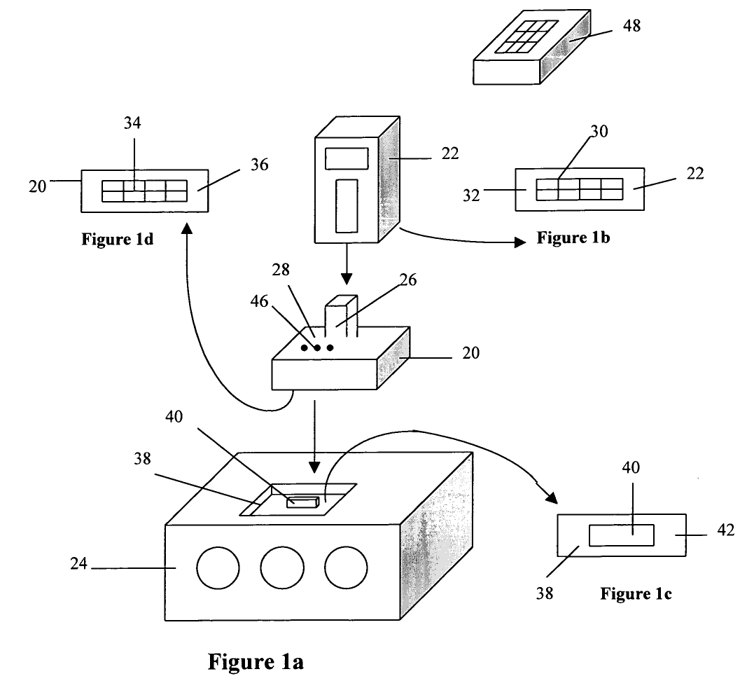

Referring to FIG. 1a, there is provided an apparatus 20 for processing incoming signals. The signals may be digital or analog. The apparatus 20 may be used together with a first device 22 and a second device 24. The first device 22 may be selected from the group comprising: another similar/identical apparatus 20 for processing incoming signals, a media player, a mobile phone, a computer, a VCR and a PDA. Similarly, the second device 24 may be selected from the group comprising: another similar/identical apparatus 20 for processing incoming signals, a set of speakers, a computer, a device with speakers, a television, and a mobile phone. It can be seen that from FIG. 1a that the first device 22 is a media player while the second device 24 is a device with speakers. It should be noted that media player includes magnetic media players like LD, VCD or DVD players.

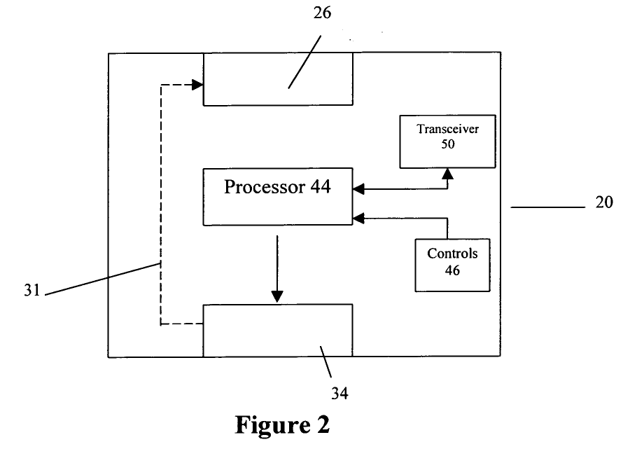

By referring to FIGS. 1 and 2, it can be seen that the apparatus 20 may include a first connecting part 26 of a first interface 28 of the apparatus 20 for operative connection with a corresponding second connecting part 30 of an interface 32 of the first device 22 (FIG. 1b). There may also be included a third connecting part 34 of a second interface 36 of the apparatus 20 (FIG. 1d) for operative connection with a corresponding fourth connecting part 40 of an interface 42 in a receptor 38 of the second device 24 (FIG. 1c). It should be noted that the second connecting part 30 of the first device 22 and the third connecting part 34 of the apparatus 20 may be identical. It should also be noted that the second connecting part 30 of the first device 22 may also be operatively connected to the fourth connecting part 40 of the second device 24. This is so as apparatus 20 may be an intermediary device. The connecting parts may be coupling parts in the form of a USB connector, an IEEE 1394 Firewire connector, an earphone jack connector, a SCART connector, an S-Video connector or a proprietary connector set.

The apparatus 20 may also include a processor 44 for processing incoming signals passing into the apparatus 20 from the first device 22 through the first interface 28 of the apparatus 20, with the processor 44 subsequently passing the processed signals through the second interface 36 of the apparatus 20 to the second device 24. The processor 44 may convert analog signals to digital signals during processing. When the first interface 28 and second interface 36 of the apparatus 20 are coupled to the first device 22 and second device respectively, a power connection 31 of the third connecting part 34 and the fourth connecting part 40 may provide electrical current to the first device 22 from the second device 24. The processor 44 may also adjust processed signals in a manner affecting audio output selected from the group comprising: volume, treble, bass, balance and fader. There may be controls 46 incorporated with the apparatus 20 for controlling the processor 44. There may also be a remote control 48 for controlling the processor 44. The processor 44 may send signals to control the first device 22 and/or the second device 24. As such, the controls 46 and the remote control 48 may be able to operatively control the first device 22 and/or the second device 24. Similar to the controls 46, the remote control 48 may also be able to control the processor 44 to adjust processed digital signals in a manner affecting audio output selected from the group comprising: volume, treble, bass, balance and fader.

In addition, the processor 44 may also process the incoming signals by restoring compressed and encoded digital signals such as, for example, signals stored as MP3, WMA, AAC, AVI, MP4, and similar file formats to approximately its original form before the signals were subjected to file compression and encoding. In this regard, the processed signals passed through the second interface 36 to the second device 24 may render higher quality playback of audio content from the first device 22 compared to the instance where apparatus 20 is not employed in the setup shown in FIG. 1a. The processor 44 may utilise proprietary processes or routines embodied in, for example, Creative Technology Ltd's X-Fi technology to process the incoming signals passing through the apparatus 20.

In addition, the apparatus 20 may include a transceiver 50 for wireless functionality using wireless technologies such as, for example, UWB, Bluetooth, infrared, or any form of radio frequency transmission. An advantage of such a feature may be when a media player/mobile phone is connected to the apparatus 20, audio content from the media player/mobile phone processed by the apparatus 20 may be wirelessly transmitted to remote listening devices. In addition, content from the media player/mobile phone may be transmitted through the transceiver 50 via Bluetooth to other Bluetooth-enabled devices. This allows for devices connected to apparatus 20 to have wireless functionality even if the facility was not built into the devices. The transceiver 50 for wireless functionality may also be controlled by the remote control 48.

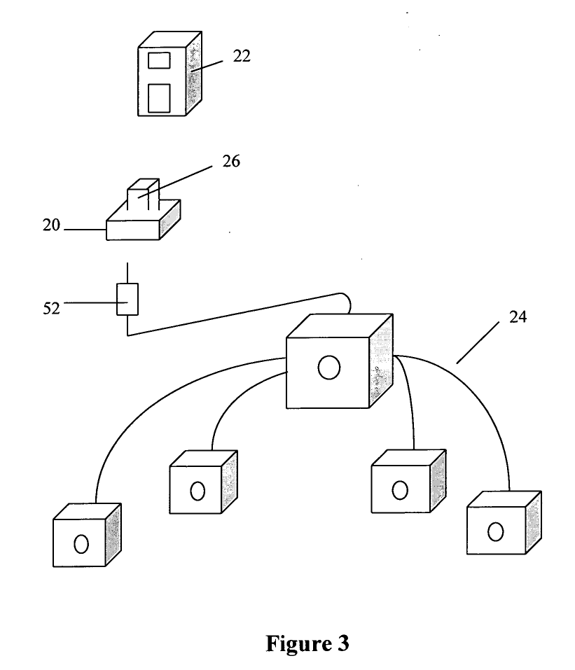

Referring to FIG. 3, there is shown the first embodiment of the present invention when in use in a second instance. In this second instance, the second device 24 is a set of 5.1 surround speakers. The second device 24 may be connected to the apparatus 20 using an earphone jack 52. As mentioned earlier, the first device 22 connectable to the apparatus 20 may be selected from the group comprising: another similar/identical apparatus 20 for processing digital signals, a media player, a mobile phone, a computer, a VCR and a PDA. As such, the apparatus 20 may also include a decoder for the second device 24. The decoder may be a part of processor 44, or it may be a separate component in apparatus 20. This allows for videos from the first device 22, if it was a video media player, to be viewed with multi-channel sound such as, for example, DTS or THX format, without the need for the first device 22 to decode the audio signals into their various channels for surround sound projection through the second device 24. The processor 44 in the apparatus 20 may also process incoming audio signals to enable the provision of multi-channel sound from video files encoded with only stereo signals. In addition, the processor 44 in the apparatus 20 may also augment incoming video signals to a high definition format for the provision of high definition images (stationery or moving).

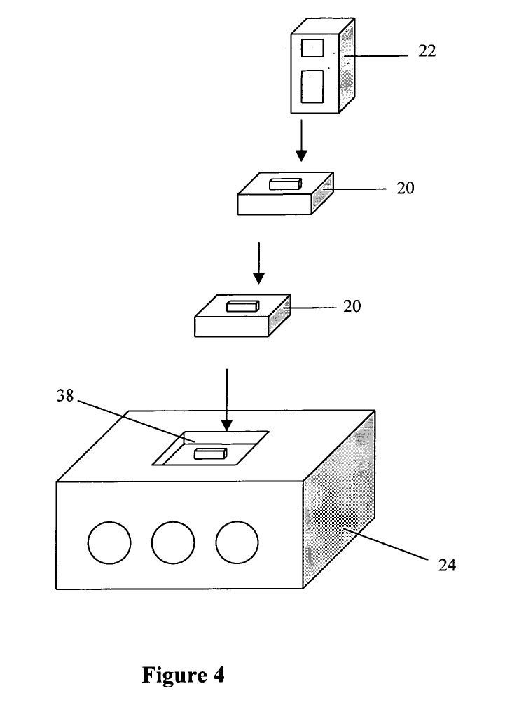

Referring to FIG. 4, there is shown the first embodiment of the present invention when in use in a third instance. In this third instance, the setup is identical to that shown in FIG. 1a, except that two apparatus 20 are now stacked and connected to one another. While both apparatus 20 may be identical, they may also be different. One apparatus 20 may have the transceiver 50 while the other may have the decoder. It may be too expensive to include both the transceiver 50 and the decoder in the apparatus 20. This may also be because the decoder only appeals to a video-watching user while the transceiver 50 only appeals to users who seek add-on wireless functionality for content transfer and/or usage of wireless listening devices (in multiple channel audio). Thus, stacking and connecting multiple apparatus 20 may enhance the functionality of the first device 22 to the specific requirement of the user. In this regard, connecting the first device 22 to two (stacked and connected) apparatus 20 enables the first device 22 to have wireless transfer functionality and the ability to provide multi channel sound, provided that the second device 24 allows for the transmission of multi channel sound. It should be noted that these functionalities are in addition to the signal processing carried out by the apparatus 20 mentioned earlier. The apparatus 20 may also be able to provide other add-on features for the first device 22, such as additional storage capacity of at least a few megabytes in the form of non-volatile memory (either a hard disk drive or flash memory) for backing up content stored in the first device 22 or synchronising content with another device connected either wired or wirelessly to apparatus 20.

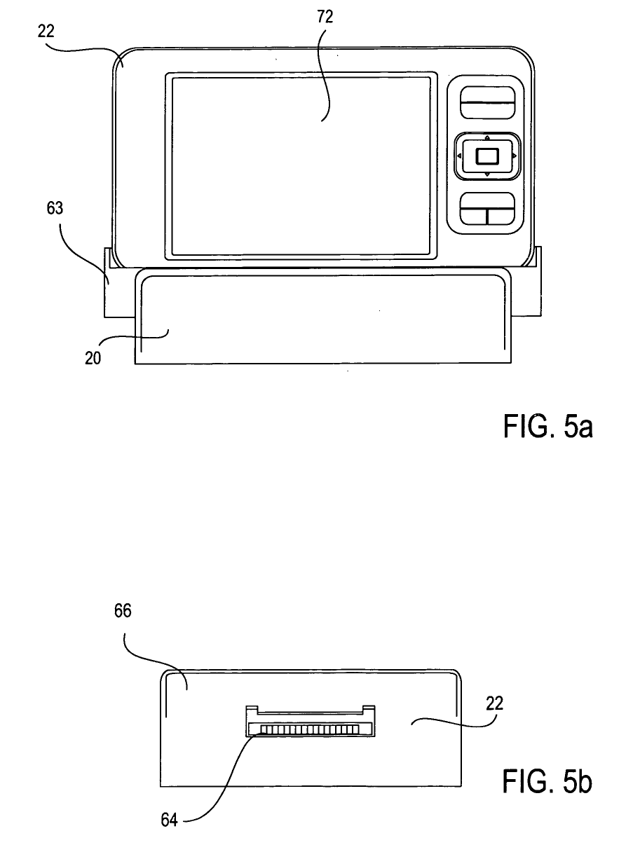

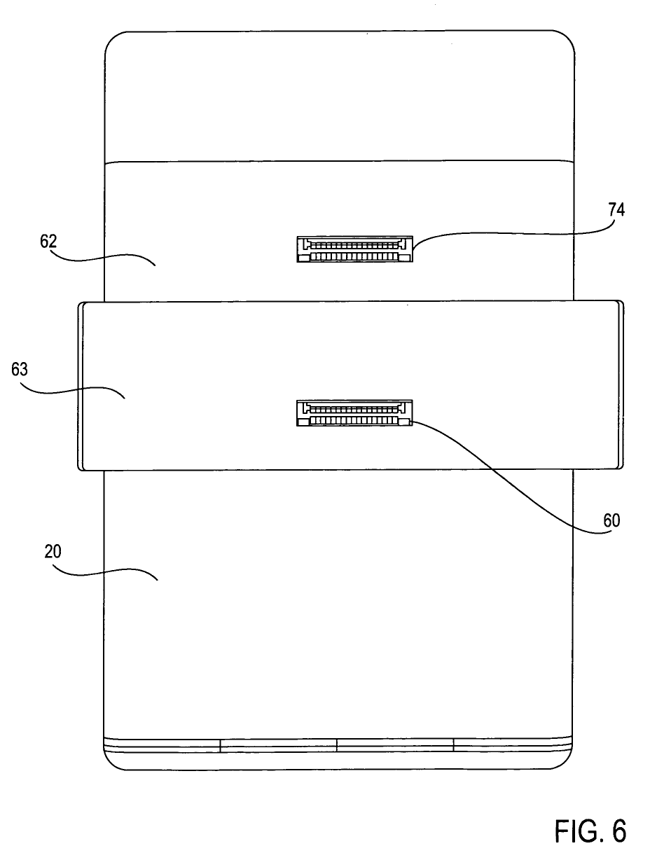

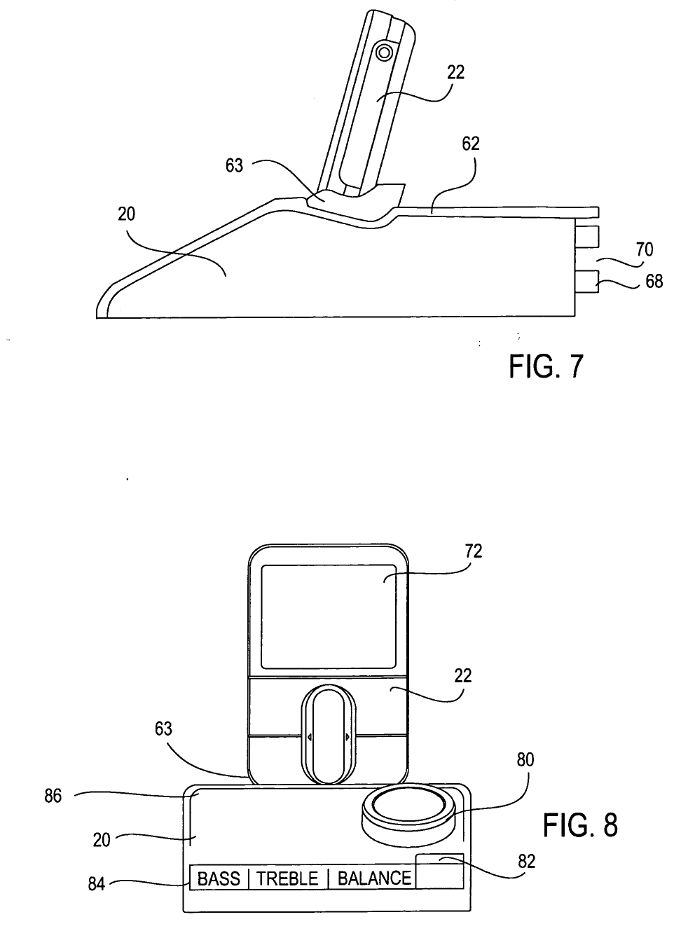

Referring to FIGS. 5-7, there is shown a second embodiment of the present invention that functions in a similar manner to the first embodiment of the present invention in the manner which signals are processed in apparatus 20. The second embodiment only differs in its physical outlook to the first embodiment. FIG. 5a shows a front view of the apparatus 20 in the form of a docking station. The first device 22 in this instance is a Zen Vision by Creative Technology Ltd. FIG. 6 shows a top view of the apparatus 20 in the form of a docking station (without the Zen Vision). The apparatus 20 may include a first connecting part 60 of a first interface 62 of the apparatus 20 for operative connection with a corresponding second connecting part 64 of an interface 66 of the first device 22 (FIG. 5a). Referring to FIG. 7, there may also be included a third connecting part 68 of a second interface 70 of the apparatus 20 for operative connection with a corresponding fourth connecting part (not shown) of a second device (not shown). As per the first embodiment of the present invention, the connecting parts may be coupling parts in the form of a USB connector, an IEEE 1394 Firewire connector, an earphone jack connector, a SCART connector, an S-Video connector or a proprietary connector set. Similar to the first embodiment, the second device may also be selected from the group comprising: another similar/identical apparatus 20 for processing digital signals, a set of speakers, a computer, a device with speakers, a television, and a mobile phone. In this second embodiment, the second interface 70 may be omitted from apparatus 20 if the purpose of apparatus 20 was to act as a transmitter to wireless devices. Similarly, the first device 22 may be selected from the group comprising: another similar/identical apparatus 20 for processing digital signals, a media player, a mobile phone, a computer, a VCR and a PDA. The apparatus 20 may enable a pair of devices with incompatible connectors to be operatively connected to each other. In the instance where the first device 22 is a magnetic media player or a VCR, the apparatus 20 may be able to process incoming signals from the first device 22 to a high definition format and subsequently transmit the processed signals to a connected second device like a high definition television.

It should be noted that a receiving structure 63 may be varied to suit a form factor of the first device 22, specifically a shape of the interface 66 of the first device 22. The receiving structure 63 may be used to support the first device 22 in a position that allows the first device 22 to remain connected to the apparatus 20 when the first device 22 is left in a stationary position. It is preferable that the stationary position allows a screen 72 of the first device 22 to be clearly visible when viewed from a reasonably broad field of view or viewing angle. However, it should be noted that the first device 22 need not have a screen.

It should be noted that the second connecting part 64 of the first device 22 and the third connecting part 68 of the apparatus 20 may be identical. It should also be noted that the second connecting part 64 of the first device 22 may also be directly and consequently operatively connected to the fourth connecting part (not shown) of the second device (not shown). The connecting parts may be coupling parts in the form of a USB connector, an IEEE 1394 Firewire connector, an earphone jack connector, a SCART connector, an S-Video connector or a proprietary connector set.

Referring to FIG. 6, there is shown a fifth connecting part 74 of the first interface 62 of the apparatus 20 for operative connection with a corresponding second connecting part 64 of an interface 66 of another first device 22. The fifth connecting part 74 of the first interface 62 may be exposed or concealable. The fifth connecting part 74 of the first interface 62 may be either identical or different from the first connecting part 60 of the first interface 62 of the apparatus 20. Having a different first connecting part 60 and fifth connecting part 74 allows for different first devices 22 to be connected to apparatus 20. Should both first devices 22 be media players, a user would then be able to access content from both media players, where the content being accessed is processed by the processor in the apparatus 20. The apparatus 20 may also allow for transfer of content between the first devices 22 connected to the apparatus 20. It should be noted that more than two first devices 22 may be connected to the apparatus 20 with the incorporation of additional connectors to the apparatus 20.

Referring to FIG. 8, there is shown a third embodiment of the present invention that functions in a similar manner to the first and second embodiments of the present invention in the manner in which signals are processed in apparatus 20. The third embodiment has additional features when compared with the second embodiment. FIG. 8 shows a front view of the apparatus 20 in the form of a docking station. In this instance, the first device 22 is a Zen Vision M by Creative Technology Ltd. In this embodiment, the apparatus 20 includes a control knob 80. The control knob 80 may be used to vary the digital signals being output after processing in apparatus 20. There may be a “mode” switch 82 included on the apparatus 20. The switch 82 may be a sensor switch or a tactile switch. By pressing the switch 82, aspects of audio output may be selected which affect volume, treble, bass, balance or fader of the audio output. Once a desired aspect of audio output is selected and reflected in indicia 84 on the apparatus 20, the control knob 80 is manipulated to control the audio output. The indicia 84 may be wordings laser etched into a casing 86 of the apparatus 20. The indicia 84 may also be shown on a display means, such as, for example, an OLED screen, a TFT screen, an LED screen, an LCD screen and so forth.

It should be noted that the apparatus 20 may be a built-in or an add-on accessory to a sound and/or video reproduction device where the apparatus 20 may be employed to alter sound and/or video reproduction quality.

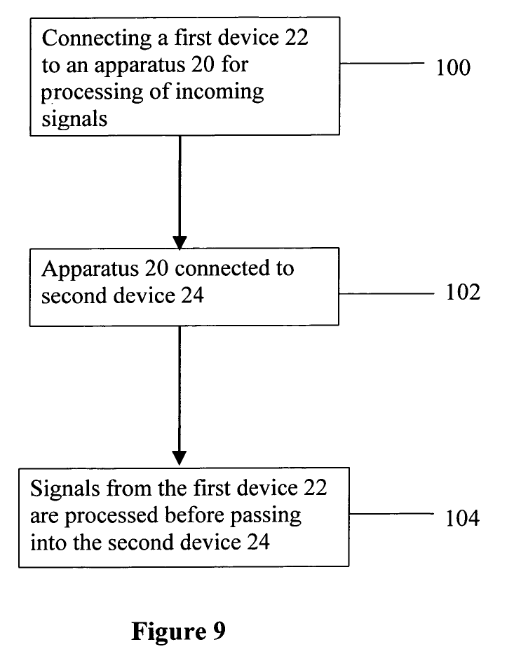

In another aspect of the present invention, there is shown in FIG. 9 a method for processing signals. The signals may be either digital or analog. Firstly, a first device 22 is connected to an apparatus 20 (100). Subsequently, the apparatus 20 is connected to a second device 24 (102). When the apparatus 20 is in use, incoming signals passing into the apparatus 20 from the first device 22 are processed and subsequently passed into the second device 24 (104). It should be noted that the order of connection of the first device 22 and the second device 24 to the apparatus 20 is inconsequential. The incoming signals may be processed using a controllable processor by restoring compressed signals to approximately its original form. The processor may utilise proprietary processes or routines embodied in Creative Technology Ltd's X-Fi technology to process the incoming signals passing through the apparatus 20. The processor may also be able to process incoming signals from the first device 22 to a high definition format. The first device 22 may be selected from the group comprising: another similar/identical apparatus 20 for processing digital signals, a media player, a mobile phone, a computer, a VCR and a PDA. Similarly, the second device 24 may be selected from the group comprising: another similar/identical apparatus 20 for processing digital signals, a set of speakers, a computer, a device with speakers, a television and a mobile phone. The aforementioned method for processing digital signals may be incorporated in a sound and/or video reproduction apparatus to alter sound and/or video reproduction quality.

It should be noted that the method shown in FIG. 9 may be incorporated into a built-in or an add-on accessory to a sound and/or video reproduction device where the method may be employed to alter sound and/or video reproduction quality.

Whilst there has been described in the foregoing description preferred embodiments of the present invention, it will be understood by those skilled in the technology concerned that many variations or modifications in details of design or construction may be made without departing from the present invention.

1. An apparatus for processing incoming signals, the apparatus comprising:
a first connector of a first interface for operative connection with a corresponding second connector of an interface of a first device;
a third connector of a second interface for operative connection with a corresponding fourth connector of an interface of a second device, and
a processor to process the incoming signals received by the apparatus from the first device through the first interface and transmitting the processed signals through the second interface to the second device.

2. The apparatus as claimed in claim 1, wherein the processor adjusts the processed signals affecting audio output in a manner selected from the group consisting of: volume, treble, bass, balance and fader.

3. The apparatus as claimed in claim 1, wherein the second device is selected from the group consisting of: another apparatus for processing digital signals, a set of speakers, a computer, a device with speakers, a television, and a mobile phone.

4. The apparatus as claimed in claim 1, wherein the incoming signals are processed in a manner selected from the group comprising: by restoring compressed signals to approximately its original form, by augmenting signals to high definition format.

5. The apparatus as claimed in claim 1, wherein the first device is selected from the group comprising: another apparatus for processing digital signals, a media player, a mobile phone, a computer, a video cassette recorder (VCR) and a personal digital assistant (PDA).

6. The apparatus as claimed in claim 1, wherein when the first interface and second interface are able to be used, a power connection of the third connector and the fourth connector is able to be used to provide electrical power to the first device from the second device.

7. The apparatus as claimed in claim 1, further comprising a fifth connector of a first interface for operative connection with a corresponding second connector of an interface of another first device.

8. The apparatus as claimed in claim 7, wherein the first connector and the fifth connector of the first interface are of the type selected from the group consisting of: identical and different.

9. The apparatus as claimed in claim 1, further comprising a transceiver for wireless communication using technologies selected from the group consisting of: UltraWideBand (UWB), Bluetooth, infrared, and any form of radio frequency transmission.

10. The apparatus as claimed in claim 9, further comprising a remote control for operative control of the processor and/or the transceiver for wireless functionality.

11. The apparatus as claimed in claim 1, further comprising a decoder for decoding the incoming signals received by the apparatus into multiple channels.

12. The apparatus as claimed in claim 1, wherein the interface of the second device resides in a receiver in the second device.

13. The apparatus as claimed in claim 1, further comprising a receiving structure to support the first device in a stationary position.

14. The apparatus as claimed in claim 13, wherein the receiving structure is interchangeable.

15. The apparatus as claimed in claim 1, wherein all the connectors are coupling parts selected from the group consisting of: a USB connector, an IEEE 1394 Firewire connector, an earphone jack connector, a SCART connector, an S-Video connector and a proprietary connector set.

16. The apparatus as claimed in claim 1, wherein the processor is controllable.

17. The apparatus as claimed in claim 1, wherein the incoming signals are selected from the group consisting of: digital and analog.

18. A method for processing incoming signals, the method comprising:
connecting a first device to an apparatus for processing incoming signals; and
connecting the apparatus to a second device,
wherein the apparatus processes the incoming signals received from the first device and transmits the processed signals to the second device.

19. The method as claimed in claim 18, wherein the first device is selected from the group consisting of: another apparatus for processing digital signals, a media player, a mobile phone, a computer, a VCR and a PDA.

20. The method as claimed in claim 18, wherein the incoming signals are processed by a processor in the apparatus.

21. The method as claimed in claim 20, wherein the incoming signals are processed in a manner selected from the group consisting of: by restoring compressed signals to approximately its original form, by augmenting signals to high definition format.

22. The method as claimed in claim 20, wherein the processor adjusts the processed signals affecting audio output in a manner selected from the group consisting of: volume, treble, bass, balance and fader.

23. The method as claimed in claim 18, wherein the incoming signals are selected from the group consisting of: digital and analog.

24. The method as claimed in claim 20, wherein the processor is controllable.

25. The method as claimed in claim 18, wherein the second device is selected from the group consisting of: another apparatus for processing digital signals, a set of speakers, a computer, a device with speakers, a television, and a mobile phone.

26. A media reproduction device comprising the apparatus as claimed in claim 1.

27. A media reproduction device configured to perform the method as claimed in claim 18.
